(19) United States
(12) Patent Application Publication
(10) Pub. No.: US 2011/0024039 A1
(43) Pub. Date: Feb. 3, 2011

(54) ONE-PART EPOXY-BASED STRUCTURAL ADHESIVE

(76) Inventors: Christopher J. Campbell, Burnsville, MN (US); Alphonsus V. Pocius, Maplewood, MN (US); Ilya Gorodisher, Stillwater, MN (US); Babu N. Gaddam, Woodbury, MN (US); Wayne S. Mahoney, St. Paul, MN (US)

Correspondence Address: 3M INNOVATIVE PROPERTIES COMPANY, PO BOX 33427, ST. PAUL, MN, 55133-3427, US

(21) Appl. No.: 12/936,150

(22) PCT Filed: Apr. 10, 2009
(86) PCT No.: PCT/US09/40164

§ 371 Date: Oct. 1, 2010

Related U.S. Application Data
(60) Provisional application No. 61/123,927, filed on Apr. 11, 2008.

(51) Int. Cl. B32B 37/12; C08L 63/00; C09J 163/00

(52) U.S. Cl. 156/330; 523/400

(57) ABSTRACT

A one-part epoxy structural adhesive comprising an epoxy resin, a toughening agent, a reactive liquid modifier present in an amount ranging from about 5% to about 15% by weight structural adhesive, and a latent amine curing agent. The structural adhesive may optionally include reactive diluents, synthetic mineral fibers, fillers, pigments and combinations th The structural adhesive may be used to form bonded joints between metal parts having clean surfaces, as well as those having surfaces contaminated with hydrocarbon-containing materials, such as oils, processing aids and lubricating agents.

### FIELD OF THE INVENTION

The present invention relates to one-part epoxy-based structural adhesive compositions, particularly an epoxy-based composition that when cured exhibits properties useful in structural assembly. The present invention also relates to uses of the structural adhesive compositions and to processes for bonding parts using the compositions.

### BACKGROUND

Structural adhesives can be defined as materials used to bond other high strength materials, such as wood, composites, or metal, so that the practical adhesive bond strength is in excess of 6.9 MPa (1,000 psi) at room temperature. Structural adhesives can have a wide variety of uses, from general-use industrial applications to high-performance applications in the automotive and aerospace industries. Structural adhesives may be used to replace or augment conventional joining techniques such as welding or mechanical fasteners (that is, nuts and bolts, screws and rivets, etc.). In particular, in the transportation industry (for example, automotive, aircraft or watercraft), structural adhesives can present a light weight alternative to mechanical fasteners. To be suitable as structural adhesives, the adhesives are required to have high mechanical strength and impact resistance.

The inherent brittleness of heat-cured epoxy-based adhesives can be overcome by adding toughening agents to the adhesive compositions which impart greater impact resistance to the cured epoxy compositions. Such attempts include the addition of elastomeric particles polymerized in situ in the epoxide from free-radical polymerizable monomers, the addition of a copolymeric stabilizer, the addition of elastomer molecules or separate elastomer precursor molecules, or the addition of core/shell polymers. Typically, a rather large amount of toughening agent may have to be employed to achieve satisfying toughening and/or impact resistance. However, large amounts of toughening agents such as, for example, core/shell polymers lead to an increased viscosity of the adhesive composition and poor handling. Therefore, there is a need for providing compositions, in particular compositions suitable as structural adhesives, having the same or even improved toughening effect and/or impact resistance at a lower level of toughening agent.

Although the use of tougheners has led to an improved impact resistance for static loads, there still is a need to provide structural epoxy-based adhesives having a good crash resistance, that is, a good impact resistance on dynamic loads. A good crash-resistance means the ability of an adhesively bonded structure to adsorb energy on sudden impact as may occur in case of a crash of a vehicle.

Additionally, in certain assembly applications, in particular where spot welding is used to join parts, fast curing adhesives may be desired, which achieve a high or improved adhesive and cohesive strength after short curing periods. For example, in automated assembly lines used in vehicle assembly, predetermined components are joined locally by spotwise induction curing. This results in partially cured areas separated by non-cured areas, where other components may be added to in subsequent process steps prior to the complete curing of the body, for example by thermal treatment of the assembly. These heating periods may be very short, for example, less than a minute. However, the induction-cured areas are required to have a sufficient adhesive and cohesive strength allowing safe mechanical handling prior to the complete curing of the assembly.

Furthermore, it is beneficial for a structural adhesive to provide sufficient adhesion to metal surfaces which are contaminated with hydrocarbon-containing material, such as mineral oils, processing aids (for example, deep-drawing agents), lubricating agents (for example, dry lubes, grease and soil), and the like. It is well-known that removing hydrocarbon-containing material from surfaces can be extremely difficult. Mechanical processes such as dry wiping and/or the use of pressurized air tend to leave a thin layer of the hydrocarbon-containing material on the metal surface. A liquid cleaning composition like that disclosed in U.S. Pat. No. 6,849,589 can be effective but may be less desirable from a processing point of view because the cleaning liquid must be collected and recycled or discarded. In addition, a drying period is usually required after the cleaning step.

Therefore, a continuing need exists for structural adhesives that exhibit one or more of the following properties: high mechanical strength and impact resistance; reasonable cure time; adherence to clean surfaces; and adherence to surfaces contaminated with hydrocarbon-containing material, such as various oils and lubricants.

### SUMMARY

In one embodiment, the invention provides an adhesive comprising an epoxy resin, a toughening agent, a reactive liquid modifier present in an amount ranging from about 5% to about 15% by weight adhesive, and a latent amine curing agent.

In another embodiment, the invention provides an adhesive comprising an epoxy resin, a toughening agent, a reactive liquid modifier, a latent amine curing agent, and an inorganic mineral fiber comprising from about 37% to about 42% by weight SiO₂, from about 18% to about 23% by weight Al₂O₃, from about 34% to about 39% by weight CaO+MgO, from 0% to about 1% by weight FeO, and about 3% by weight K₂O+Na₂O.

In a further embodiment, the invention provides a method of forming a bonded joint between two substrates comprising providing an adhesive comprising an epoxy resin, a toughening agent, a reactive liquid modifier present in an amount ranging from about 5% to about 15% by weight adhesive, and a latent amine curing agent, applying the adhesive to at least one of two substrates, joining the substrates so that the adhesive is sandwiched between the two substrates, and curing the adhesive to form a bonded joint.

In yet a further embodiment, the invention provides a method of forming a bonded joint between two substrates comprising providing an adhesive comprising an epoxy resin, a toughening agent, a reactive liquid modifier, a latent amine curing agent, and an inorganic mineral fiber comprising from about 37% to about 42% by weight SiO₂, from about 18% to about 23% by weight Al₂O₃, from about 34% to about 39% by weight CaO+MgO, from 0% to about 1% by weight FeO, and about 3% by weight K₂O+Na₂O, applying the adhesive to at least one of two substrates, joining the substrates so that the adhesive is sandwiched between the two substrates, and curing the adhesive to form a bonded joint.

Other features and aspects of the invention will become apparent by consideration of the detailed description.

### DETAILED DESCRIPTION

Before any embodiments of the invention are explained in detail, it is to be understood that the invention is not limited in its application to the details of construction and the arrangement of components set forth in the following description. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Any numerical range recited herein includes all values from the lower value to the upper value. For example, if a concentration range is stated as 1% to 50%, it is intended that values such as 2% to 40%, 10% to 30%, or 1% to 3%, etc., are expressly enumerated in this specification. These are only examples of what is specifically intended, and all possible combinations of numerical values between and including the lowest value and the highest value enumerated are to be considered to be expressly stated in this application.

The present invention relates to a one-part epoxy-based structural adhesive comprising at least one epoxy resin, at least one toughening agent, at least one reactive liquid modifier and at least one latent amine curing agent. The structural adhesive may optionally include other ingredients such as, but not limited to, reactive diluents, synthetic mineral fibers, fillers, pigments and combinations thereof The structural adhesives may be used to replace or augment conventional joining means such as welds or mechanical fasteners in bonding parts together.

### Epoxy Resins

Epoxy resins function as a cross-linkable component in the structural adhesive. The term “epoxy resin” is used herein to mean any of monomeric, dimeric, oligomeric or polymeric epoxy materials containing at least one epoxy functional group per molecule. Such compounds include monomeric epoxy compounds and epoxides of the polymeric type and can be aliphatic, cycloaliphatic, aromatic or heterocyclic. Monomeric and oligomeric epoxy compounds have at least one and preferably one to four polymerizable epoxy groups per molecule. In polymeric type epoxides or epoxy resins, there may be many pendent epoxy groups (for example, a glycidyl methacrylate polymer could have several thousand pendent epoxy groups per average molecular weight). Oligomeric epoxy resins and, in particular, polymeric epoxy resins are preferred.

The molecular weight of the epoxy resins may vary from low molecular weight monomeric or oligomeric epoxy resins with a molecular weight, for example, from about 100 g/mol to epoxy resins with a molecular weight of about 50,000 g/mol or more and may vary greatly in the nature of their backbone and substituent groups. For example, the backbone may be of any type, and substituent groups thereon can be any group not having a nucleophilic group or electrophilic group (such as an active hydrogen atom) which is reactive with an oxirane ring. Illustrative of permissible substituent groups are halogens, ester groups, ethers, sulfonate groups, siloxane groups, nitro groups, amide groups, nitrile groups, phosphate groups, etc. Mixtures of epoxy resins can also be used. In some embodiments, a structural adhesive comprises a mixture of two or more epoxy resins in order to modify and adapt the mechanical properties of the cross-linked structural adhesive with respect to specific requirements.

Types of epoxy resins that can be used include, for example, the reaction product of bisphenol A and epichlorohydrin, the reaction product of phenol and formaldehyde (novolac resin) and epichlorohydrin, peracid epoxies, glycidyl esters, glycidyl ethers, the reaction product of epichlorohydrin and p-amino phenol, the reaction product of epichlorohydrin and glyoxal tetraphenol and the like.

Epoxides that are particularly useful in the present invention are of the glycidyl ether type. Suitable glycidyl ether epoxides may include those in general formula (I):

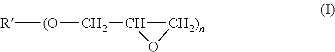

wherein

R′ is alkyl, alkyl ether, or aryl;

n is at least 1 and, in particular, in the range from 1 to 4.

Suitable glycidyl ether epoxides of formula (I) include glycidyl ethers of Bisphenol A and F, aliphatic diols or cycloaliphatic diols. In some embodiments the glycidyl ether epoxides of formula (I) have a molecular weight in the range of from about 170 g/mol to about 10,000 g/mol. In other embodiments, the glycidyl ether epoxides of formula (I) have a molecular weight in the range of from about 200 g/mol to about 3,000 g/mol.

Useful glycidyl ether epoxides of formula (I) include linear polymeric epoxides having terminal epoxy groups (for example, a diglycidyl ether of polyoxyalkylene glycol) and aromatic glycidyl ethers (for example, those prepared by reacting a dihydric phenol with an excess of epichlorohydrin). Examples of useful dihydric phenols include resorcinol, catechol, hydroquinone, and the polynuclear phenols including p,p′-dihydroxydibenzyl, p,p′-dihydroxyphenylsulfone, p,p′-dihydroxybenzophenone, 2,2′-dihydroxyphenyl sulfone, p,p′-dihydroxybenzophenone, 2,2-dihydroxy-1,1-dinaphrhylmethane, and the 2,2′, 2,3′, 2,4′, 3,3′, 3,4′, and 4,4′ isomers of dihydroxydiphenylmethane, dihydroxydiphenyldimethylmethane, dihydroxydiphenylethylmethylmethane, dihydroxydiphenylmethylpropylmethane, dihydroxydiphenylethylphenylmethane, dihydroxydiphenylpropylenphenylmethane, dihydroxydiphenylbutylphenylmethane, dihydroxydiphenyltolylethane, dihydroxydiphenyltolylmethylmethane, dihydroxydiphenyldicyclohexylmethane, and dihydroxydiphenylcyclohexane.

Suitable commercially available aromatic and aliphatic epoxides include diglycidylether of bisphenol A (for example, available under the tradename EPON 828, EPON 872, EPON 1001, EPON 1310 and EPONEX 1510 from Hexion Specialty Chemicals GmbH in Rosbach, Germany), DER-331, DER-332, and DER-334 (available from Dow Chemical Co. in Midland, Mich.); diglycidyl ether of bisphenol F (for example, EPICLON 830 available from Dainippon Ink and Chemicals, Inc.); PEG₁₀₀₀DGE (available from Polysciences, Inc. in Warrington, Pa.); silicone resins containing diglycidyl epoxy functionality; flame retardant epoxy resins (for example, DER 580, a brominated bisphenol type epoxy resin available from Dow Chemical Co. in Midland, Mich.); 1,4-dimethanol cyclohexyl diglycidyl ether; and 1,4-butanediol diglycidyl ether. Other epoxy resins based on bisphenols are commercially available under the tradenames D.E.N., EPALLOY and EPILOX.

In some embodiments, the structural adhesives of the present invention may comprise from about 20% to about 90% by weight epoxy resin. In other embodiments, the structural adhesives may comprise from about 40% to about 70% by weight epoxy resin. In yet other embodiments, the structural adhesives may comprise from about 60% to about 70% by weight epoxy resin.

### Reactive Liquid Modifiers

Addition of reactive liquid modifiers to the adhesive formulation imparts flexibility to the epoxy resin and enhances the effect of the toughening agent in the resultant adhesive.

Reactive liquid modifiers of the present invention may include acetoacetoxy-functionalized compounds containing at least one acetoacetoxy group, preferably in a terminal position. Such compounds include acetoacetoxy group(s) bearing hydrocarbons, such as alkyls, polyether, polyols, polyester, polyhydroxy polyester, polyoxy polyols, or combinations thereof.

The acetoacetoxy-functionalized compound may be a polymer. In some embodiments, the acetoacetoxy-functionalized compounds of the present invention may have a molecular weight of from about 100 g/mol to about 10,000 g/mol. In other embodiments, the acetoacetoxy-functionalized compounds may have a molecular weight of from about 200 g/mol to about 1,000 g/mol. In yet other embodiments, the acetoacetoxy-functionalized compounds may have a molecular weight of from about 150 g/mol to less than about 4,000 g/mol or less than about 3,000 g/mol. Suitable compounds include those having the general formula (II)

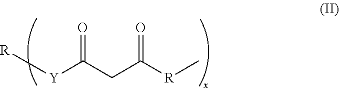

wherein

X is an integer from 1 to 10, preferably from 1 to 3;

Y represents O, S or NH, preferably Y is O;

R represents a residue selected from the group of residues consisting of polyhydroxy alkyl, polyhydroxy aryl or a polyhydroxy alkylaryl; polyoxy alkyl, polyoxy aryl and polyoxy alkylaryl; polyoxy polyhydroxy alkyl, -aryl, -alkylaryl; polyether polyhydroxy alkyl, -aryl or -alkylaryl; or polyester polyhydroxy alkyl, -aryl or -alkylaryl, wherein R is linked to Y via a carbon atom. In some embodiments, R represents a polyether polyhydroxy alkyl, -aryl or -alkylaryl residue, or a polyester polyhydroxy alkyl, -aryl or -alkylaryl residue.

The residue R may, for example, contain from 2 to 20 or from 2 to 10 carbon atoms. The residue R may, for example, also contain from 2 to 20 or from 2 to 10 oxygen atoms. The residue R may be linear or branched.

Examples of polyesterpolyol residues include polyesterpolyols obtainable from condensation reactions of a polybasic carboxylic acid or anhydrides and a stoichiometric excess of a polyhydric alcohol, or obtainable from condensation reactions from a mixture of polybasic acids, monobasic acids and polyhydric alcohols. Examples of polybasic carboxylic acids, monobasic carboxylic acids or anhydrides include those having from 2 to 18 carbon atoms. In some embodiments, the polybasic carboxylic acids, the monobasic carboxylic acids or the anhydrides have from 2 to 10 carbon atoms.

Examples of polybasic carboxylic acids or anhydrides include adipic acid, glutaric acid, succinic acid, malonic acid, pimleic acid, sebacic acid, suberic acid, azelaic acid, cyclohexane-dicarboxylic acid, phthalic acid, isophthalic acid, terephthalic acid, hydrophthalic acid (for example, tetrahydro or hexadehydrophthalic acid) and the corresponding anhydrides, as well as combinations thereof.

Examples of monobasic carboxylic acids include formic acid, acetic acid, propionic acid, butyric acid, valeric acid, caproic acid, caprylic acid, capric acid, lauric acid, myristic acid, palmitic acid, stearic acid and the like, as well as combinations thereof.

Polyhydric alcohols include those having from 2 to 18 carbon atoms. In some embodiments, the polyhydric alcohols include those having from 2 to 10 carbon atoms. Examples of polyhydric alcohols include ethylene glycol, propylene glycol, butylene glycol, hexylene glycol, pentaerythriol, glycerol and the like, including polymers thereof.

Examples of polyetherpolyol residues include those derived from polyalkylene oxides. Typically, the polyalkylene oxides contain alkylene groups from about 2 to about 8 carbon atoms. In some embodiments, the polyalkylene oxides contain alkylene groups from about 2 to about 4 carbon atoms. The alkylene groups may be linear or branched but are preferably linear. Examples of polyetherpolyol residues include polyethylene oxide polyol residues, polypropylene oxide polyol residues, polytetramethylene oxide polyol residues, and the like.

R′ represents a C₁-C₁₂ linear or branched or cyclic alkyl such as methyl, ethyl, propyl, butyl, sec-butyl, tert-butyl, etc.

The acetoacetoxy-functionalized oligomers can be prepared by acetacetylation of polyhydroxy compounds with alkyl acetoacetates, diketene or other acetoacetylating compounds as, for example, described in EP 0 847 420 B1.

Other polyhydroxy compounds may be a copolymer of acrylates and/or methacrylates and one or more unsaturated monomers containing a hydroxyl group. Further examples of polyhydroxy polymers include hydroxyl-terminated copolymers of butadiene and acrylonitrile, hydroxy-terminated organopolysiloxanes, polytetrahydrofuran polyols, polycarbonate polyols or caprolactone based polyols.

Acetoacetoxy-functionalized polymers are commercially available, for example, as K-FLEX XM-B301 and K-FLEX 7301 (both available from King Industries, Norwalk, Conn.). Other acetoacetoxy-functionalized compounds include MaAcAc 1000 MW Oligomer, MaAcAc 2000 MW Oligomer, Urethane diAcAc #1, and Urethane diAcAc #2, the synthesis for each of which is described in Example 11.

Reactive liquid modifiers of the present invention may also include oxamides. Suitable oxamide-based modifiers may include oxamido ester terminated polypropylene oxide, the synthesis of which is also described in Example 11.

In some embodiments, the structural adhesives of the present invention may comprise from about 5% to about 15% by weight reactive liquid modifier. In other embodiments, the structural adhesives may comprise from about 7% to about 12% by weight reactive liquid modifier. In yet other embodiments, the structural adhesives may comprise from about 8% to about 10% by weight reactive liquid modifier.

### Toughening Agent

Toughening agents are polymers, other than the epoxy resins or the reactive liquid modifiers, capable of increasing the toughness of cured epoxy resins. The toughness can be measured by the peel strength of the cured compositions. Typical toughening agents include core/shell polymers, butadiene-nitrile rubbers, acrylic polymers and copolymers, etc. Commercially available toughening agents include Dynamar™ Polyetherdiamine HC 1101 (available from 3M Corporation in St. Paul, Minn.) and carboxyl-terminated butadiene acrylonitrile (available from Emerald Chemical in Alfred, Me.).

In some embodiments, the structural adhesives of the present invention may comprise from about 5% to about 55% by weight toughening agent. In other embodiments, the structural adhesives may comprise from about 5% to about 30% by weight toughening agent. In yet other embodiments, the structural adhesives may comprise from about 5% to about 15% by weight toughening agent.

Preferred toughening agents are core/shell polymers. A core/shell polymer is understood to mean a graft polymer having a core comprising a graftable elastomer, which means an elastomer on which the shell can be grafted. The elastomer may have a glass transition temperature lower than 0° C. Typically the core comprises or consists of a polymer selected from the group consisting of a butadiene polymer or copolymer, an acrylonitrile polymer or copolymer, an acrylate polymer or copolymer or combinations thereof. The polymers or copolymers may be cross-linked or not cross-linked. Preferably, the core polymers are cross-linked.

Onto the core is grafted one or more polymers, the “shell”. The shell polymer typically has a high glass transition temperature, that is, a glass transition temperature greater than 26° C. The glass transition temperature may be determined by dynamic mechanical thermo analysis (DMTA) (“Polymer Chemistry, The Basic Concepts, Paul C. Hiemenz, Marcel Dekker 1984).

The “shell” polymer may be selected from the group consisting of a styrene polymer or copolymer, a methacrylate polymer or copolymer, an acrylonitrile polymer or copolymer, or combinations thereof. The thus created “shell” may be further functionalized with epoxy groups or acid groups. Functionalization of the “shell” may be achieved, for example, by copolymerization with glycidylmethacrylate or acrylic acid. In particular, the shell may comprise acetoacetoxy moieties in which case the amount of acetoacetoxy-functionalized polymer may be reduced, or it may be completely replaced by the acetoacetoxy-functionalized core/shell polymer.

Typical core/shell polymers that may be used are core/shell polymers comprising a polyacrylate shell such as, for example, a polymethylmethacrylate shell. The polyacrylate shell, such as the polymethylmethacrylate shell, may not be cross-linked.

Typically, the core/shell polymer that may be used comprises or consists of a butadiene polymer core or a butadiene copolymer core such as, for example, a butadiene-styrene copolymer core. The butadiene or butadiene copolymer core such as the butadiene-styrene core may be cross-linked.

In some embodiments, the core/shell polymer according to the present invention may have a particle size from about 10 nm to about 1,000 nm. In other embodiments, the core/shell polymer may have a particles size from about 150 nm to about 500 nm.

Suitable core/shell polymers and their preparation are, for example, described in U.S. Pat. No. 4,778,851. Commercially available core/shell polymers may include, for example, PARALOID EXL 2600 and PARALOID EXL 2691 (available from Rohm & Haas Company in Philadelphia, Pa.) and KANE ACE MX120 (available from Kaneka in Belgium).

### Curing Agent

Curing agents suitable in the present invention include latent amine curing components. The term “latent” means that the curing component is essentially unreactive at room temperature but rapidly reacts to effect curing once the onset temperature of the epoxy curing reaction has been exceeded. This allows the structural adhesive to be readily applied at room temperature (about 23±3° C.) or with gentle warming without activating the curative (that is, at a temperature that is less than the reaction temperature for the curative).

Suitable latent amines include, for example, guanidines, substituted guanidines (for example, methylguanidine, dimethylguanidine, trimethylguanidine, tetramethylguanidine, methylisobiguanidine, dimethylisobiguanidine, tetramethylisobiguanidine, hexamethylisobiguanidine, heptamethylisobiguanidine and dicyandiamide), substituted ureas, melamine resins, guanamine derivatives (for example, alkylated benzoguanamine resins, benzoguanamine resins and methoxymethylethoxymethylbenzoguanamine), cyclic tertiary amines, aromatic amines, substituted ureas (for example, p-chlorophenyl-N,N-dimethylurea (monuron), 3-phenyl-1,1-dimethylurea (fenuron), 3,4-dichlorophenyl-N,N-dimethylurea (diuron)), tertiary acryl- or alkyl-amines (for example, benzyldimethylamine, tris(dimethylamino)phenol, piperidine and piperidine derivatives), imidazole derivatives (for example, 2-ethyl-2-methylimidazole, N-butylimidazole, benzimidazole, N—C₁ to C₁₂-alkylimidazoles and N-arylimidazoles), and combinations thereof. Commercially available latent amines include ANCAMINE® Series (2014, 2337 and 2441) available from Air Products in Manchester, U.K. or Adeka Hardener Series (EH-3615, EH-43375, and EH-4342S) available from Adeka Corp. in Japan.

In some embodiments, the structural adhesives of the present invention may comprise from about 5% to about 25% by weight curing agent. In other embodiments, the structural adhesives may comprise from about 10% to about 20% by weight curing agent. In yet other embodiments, the structural adhesives may comprise from about 12% to about 18% by weight curing agent.

### Other Ingredients

The compositions may further comprise adjuvants such reactive diluents, inorganic mineral fibers, fillers and pigments.

Reactive diluents may be added to control the flow characteristics of the adhesive composition. Suitable diluents can have at least one reactive terminal end portion and, preferably, a saturated or unsaturated cyclic backbone. Reactive terminal end portions include glycidyl ether. Examples of suitable diluents include the diglycidyl ether of resorcinol, diglycidyl ether of cyclohexane dimethanol, diglycidyl ether of neopentyl glycol, triglycidyl ether of trimethylolpropane. Commercially available reactive diluents are for example Reactive Diluent 107 (available from Hexion Specialty Chemical in Houston, Tex.) and EPODIL 757 (available from Air Products and Chemical Inc. in Allentown, Pa.).

Inorganic mineral fibers are fibrous inorganic substances made primarily from rock, clay, slag, or glass. Mineral fibers may include fiberglass (glasswool and glass filament), mineral wool (rockwool and slagwool) and refractory ceramic fibers. Particularly suitable mineral fibers may have fiber diameters on the average of less than 10 μm. Mineral fibers may comprise from about 37% to about 42% by weight SiO₂, from about 18% to about 23% by weight Al₂O₃, from about 34% to about 39% by weight CaO+MgO, from 0% to about 1% by weight FeO, and about 3% by weight K₂O+Na₂O. Commercially available fibers include, for example, COATFORCE® CF50 and COATFORCE® CF10 (available from Lapinus Fibres BV in Roermond, The Netherlands). In some embodiments, the structural adhesives of the present invention may comprise from about 0% to about 20% by weight mineral fiber. In other embodiments, the structural adhesives may comprise from about 2% to about 15% by weight mineral fiber. In yet other embodiments, the structural adhesives may comprise from about 4% to about 8% by weight mineral fiber.

Fillers may include adhesion promoters, corrosion inhibitors and rheology controlling agents. Fillers may include silica-gels, Ca-silicates, phosphates, molybdates, fumed silica, clays such as bentonite or wollastonite, organo-clays, aluminium-trihydrates, hollow-glass-microspheres; hollow-polymeric microspheres and calcium-carbonate. Exemplary commercial fillers include SHIELDEX AC5 (a synthetic amorphous silica, calcium hydroxide mixture available from W.R. Grace in Columbia, Md., USA); CAB-O-SIL TS 720 (a hydrophobic fumed silica-treated with polydimethyl-siloxane-polymer available from Cabot GmbH in Hanau, Germany); AEROSIL VP-R-2935 (a hydrophobically fumed silica available from Degussa in Düsseldorf, Germany); glass-beads class IV (250-300 microns): Micro-billes de verre 180/300 (available from CVP S.A. in France); glass bubbles K37: amorphous silica (available from 3M Deutschland GmbH in Neuss, Germany); MINSIL SF 20 (available from Minco Inc., 510 Midway, Tennessee, USA); amorphous, fused silica; and APYRAL 24 ESF (epoxysilane-functionalized (2 wt %) aluminium trihydrate available from Nabaltec GmbH in Schwandorf, Germany). The structural adhesives of the present invention may comprise from about 0% to about 50% by weight filler.

Pigments may include inorganic or organic pigments including ferric oxide, brick dust, carbon black, titanium oxide and the like.

### Structural Adhesive Compositions

The structural adhesives of the present invention are made by combining together at least one epoxy resin, at least one toughening agent, at least one reactive liquid modifier and at least one latent amine curing agent. Other ingredients may be added to the formulation including, but not limited to, inorganic mineral fibers, reactive diluents, fillers and pigments.

Generally, the structural adhesives of the present invention are made by adding one or more epoxy resins to a container. If two or more epoxy resins are used, the resins are mixed until homogenized. Then one or more thickening agents are slowly added and mixed into the epoxy resin over a period of about 15 minutes. This mixture is subsequently heated to about 80° C. and maintained at that temperature for a period of about 90 minutes. The mixture is then removed from the heat and allowed to cool to room temperature. At room temperature, one or more reactive liquid modifiers are added to the mixture and mixed until homogeneous. Next, one or more curing agents are added to the mixture and mixed until homogeneous. Other ingredients, such as reactive fillers and/or mineral fibers, may be added to the mixture at this point and thoroughly mixed. After all ingredients have been added, the mixture is degassed and sealed in a closed container. The resultant adhesive may be stored at room temperature until use, preferably the adhesive is stored at about 4° C.

The structural adhesives of the present invention may have, when cured, one or more of the following mechanical properties: a cohesive strength, as measured by overlap shear of at least 2500 psi; resistance to ageing; reasonable cure time; adherence to clean metal surfaces; and adherence to metal surfaces contaminated with hydrocarbon-containing material, such as various oils and lubricants.

### Curing

Partial Curing. In some embodiments according to the present invention, the composition may reach a desirable cohesive strength after short heat curing periods. Since the cohesive strength can still increase when curing the composition at the same conditions for longer periods, this kind of curing is referred to herein as partial curing. In principle, partial curing can be carried out by any kind of heating. In some embodiments, induction curing may be used for partial curing. Induction curing is a non-contact method of heating using electric power to generate heat in conducting materials by placing an inductor coil through which an alternating current is passed in proximity to the material. The alternating current in the work coil sets up an electromagnetic field that creates a circulating current in the work piece. This circulating current in the work piece flows against the resistivity of the material and generates heat. Induction curing equipment can be commercially obtained, for example, EWS from IFF-GmbH in Ismaning, Germany.

Complete Curing. Complete curing is achieved when the cohesive strength and/or adhesive strength no longer increases when continuing to heat-cure the sample at the same conditions. Complete curing can be achieved by heating the mixture at the appropriate temperature for the appropriate length of time. In some embodiments, full (complete) cure may be brought about by heating the adhesive composition to a temperature in the range of from about 110° C. to about 210° C. In other embodiments, full cure may be brought about by heating the adhesive composition to a temperature in the range of from about 120° C. to about 180° C. Depending on the curing temperature, the heating time to affect complete cure may be at least 10 minutes. In some embodiments, the heating time is at least 20 minutes. In other embodiments, the heating time is at least 30 minutes. In yet other embodiments, curing time ranges from about 10 minutes to about 1 hour.

Bond Strength. It is desirable for the epoxy adhesive to build a strong, robust bond to one or more substrates upon curing. A bond is considered robust if the bond breaks apart cohesively at high shear values when tested in an overlap shear test and high T-peel values when tested in a T-peel test. The bonds may break in three different modes: (1) the adhesive splits apart, leaving portions of the adhesive adhered to both metal surfaces in a cohesive failure mode; (2) the adhesive pulls away from either metal surface in an adhesive failure mode; or (3) a combination of adhesive and cohesive failure. Structural adhesives of the present invention may exhibit a combination of adhesive and cohesive failure, more preferably cohesive failure during overlap shear testing and T-peel testing. The adhesive may be applied to clean substrates or oiled substrates.

In some embodiments, structural adhesives of the present invention may have a lap shear strength of at least 2500 psi when cured at 110° C. for 30 minutes. In other embodiments, the structural adhesives may have a lap shear strength of at least 3000 psi. In yet other embodiments, the structural adhesives may have a lap shear strength of at least 3500 psi.

In some embodiments, structural adhesives of the present invention may have a lap shear strength of at least 3000 psi when cured at 125° C. for 30 minutes. In other embodiments, the structural adhesives may have a lap shear strength of at least 3500 psi. In yet other embodiments, the structural adhesives may have a lap shear strength of at least 4000 psi.

In some embodiments, the structural adhesives of the present invention may have a lap shear strength of at least 2500 psi when cured at 177° C. for 20 minutes. In other embodiments, the structural adhesives of the present invention may have a lap shear strength of at least 3500 psi. In yet other embodiments, the structural adhesives may have a lap shear strength of at least 4000 psi. In further embodiments, the structural adhesives may have a lap shear strength of at least 4500 psi.

In some embodiments, the structural adhesives of the present invention may have a T-peel strength of at least 3.0 lb_{f}/in-width when cured at 110° C. for 30 minutes. In other embodiments, the structural adhesives may have a T-peel strength of at least 7.0 lb_{f}/in-width. In yet other embodiments, the structural adhesives may have a T-peel strength of at least 10.0 lb_{f}/in-width.

In some embodiments, the structural adhesives of the present invention may have a T-peel strength of at least 15.0 lb_{f}/in-width when cured at 125° C. for 30 minutes. In other embodiments, the structural adhesives may have a T-peel strength of at least 30.0 lb_{f}/in-width. In yet other embodiments, the structural adhesives may have a T-peel strength of at least 40.0 lb_{f}/in-width.

In some embodiments, the structural adhesives of the present invention may have a T-peel strength of at least 25.0 lb_{f}/in-width when cured at 177° C. for 20 minutes. In other embodiments, the structural adhesives may have a T-peel strength of at least 45 lb_{f}/in-width. In yet other embodiments, the structural adhesives may have a T-peel strength of at least 55 lb_{f}/in-width.

Structural adhesives of the present invention may have a lap shear strength of at least 2500 psi and a T-peel strength of at least 3.0 lb_{f}/in-width when cured at 110° C. for 30 minutes. Additionally, structural adhesives of the present invention may have a lap shear strength of at least 3000 psi and a T-peel strength of at least 15 lb_{f} /in-width when cured at 125° C. for 30 minutes. Furthermore, structural adhesives of the present invention may have a lap shear strength of at least 2500 psi and a T-peel strength of at least 25.0 lb_{f}/in-width when cured at 177° C. for 20 minutes. Additionally, structural adhesives of the present invention may have a lap shear strength of at least 4500 psi and a T-peel strength of at least 25.0 lb_{f}/in-width when cured at 177° C. for 20 minutes.

### Uses of Adhesive Compositions

The present adhesive compositions may be used to supplement or completely eliminate a weld or mechanical fastener by applying the adhesive composition between two parts to be joined and curing the adhesive to form a bonded joint. The adhesive may be applied to any part (or substrate) having a surface energy of about 42 dynes/cm or greater. Suitable substrates onto which the adhesive of the present invention may be applied include metals (for example, steel, iron, copper, aluminum, etc., including alloys thereof), carbon fiber, glass fiber, glass, epoxy fiber composites, and mixtures thereof. In some embodiments, at least one of the substrates is a metal. In other embodiments, both substrates are metal.

The surface of the substrates may be cleaned prior to application of the structural adhesive. However, the structural adhesive of the present invention is also useful in applications where the adhesive is applied to substrates having hydrocarbon-containing material on the surface. In particular, the structural adhesive may be applied to steel surfaces contaminated with mill oil, cutting fluid, draw oil, and the like.

In areas of adhesive bonding, the adhesive can be applied as liquid, paste, and semi-solid or solid that can be liquefied upon heating, or the adhesive may be applied as a spray. It can be applied as a continuous bead, in intermediate dots, stripes, diagonals or any other geometrical form that will conform to forming a useful bond. In some embodiments, the adhesive composition is in a liquid or paste form.

The adhesive placement options may be augmented by welding or mechanical fastening. The welding can occur as spot welds, as continuous seam welds, or as any other welding technology that can cooperate with the adhesive composition to form a mechanically sound joint.

The composition according to the present invention may be used as structural adhesives. In particular, it may be used as structural adhesive in vehicle assembly, such as the assembly of watercraft vehicles, aircraft vehicles or motorcraft vehicles, such as cars, motor bikes or bicycles. In particular, the adhesive compositions may be used as hem-flange adhesive. The adhesive may also be used in body frame construction. The compositions may also be used as structural adhesives in architecture or as structural adhesive in household and industrial appliances.

The composition according to the invention may also be used as welding additive.

The composition may be used as a metal—metal adhesive, metal-carbon fiber adhesive, carbon fiber-carbon fiber adhesive, metal-glass adhesive, carbon fiber-glass adhesive.

Exemplary embodiments of the present invention are provided in the following examples. The following examples are presented to illustrate the present invention and methods for applying the present invention and to assist one of ordinary skill in making and using the same. The examples are not intended in any way to otherwise limit the scope of the invention.

### Examples

### Materials Employed

AEROSIL VP-R-2935 (available from Degussa in Düsseldorf, Germany) is a hydrophobically fumed silica.

ANCAMINE 2441 (available from Air Products in Allentown, Pa.) is a latent modified polyamine.

APYRAL 24 ES2 (available from Nabaltec GmbH in Schwandorf, Germany) is an epoxysilane-functionalized (2% w/w) aluminum trihydrate filler.

CAB-O-SIL TS 720 (available from Cabot GmbH in Hanau, Germany) is a hydrophobic fumed silica-treated with polydimethyl-siloxane-polymer.

COATFORCE® CF50 (available from Lapinus Fibres BV in Roermond, The Netherlands) is a mineral fiber.

DER 732 (available from Dow Chemical in Midland, Mich.).

EPON 828 (available from Hexion Specialty Chemicals in Houston, Tex.) is the diglycidyl ether of bis-phenol A having an approximate epoxy equivalent weight of 187.5.

EPON 872 (available from Hexion Specialty Chemicals in Houston, Tex.) is a fatty-acid modified diglycidyl ether of bis-phenol A having an approximate epoxy equivalent weight of 625-725.

EPON 1001F (available from Hexion Specialty Chemicals in Columbus, Ohio) is a low molecular weight solid epoxy resin derived from a liquid epoxy resin and bisphenol-A, with an epoxide equivalent weight of 525-550.

EPONEX 1510 (available from Hexion Specialty Chemicals in Houston, Tex.) is the diglycidyl ether of hydrogenated bis-phenol A having an approximate epoxy equivalent weight of 210.

Glass beads, 212-300 μm in diameter (available from Sigma-Aldrich in Milwaukee, Wis.) are used as spacers.

IOTGA (available from TCI America in Portland, Oreg.) is an isooctyl ester of thioglycidic acid.

JEFFAMINE® D-400 Polyetheramine (available from Huntsman Corporation in The Woodlands, Tex.).

K-FLEX XM-311 (available from King Industries in Norwalk, Conn.) is a polyurethane polyol.

K-FLEX XMB-301 (available from King Industries in Norwalk, Conn.) is a tri-acetoacetate functional ester.

K-FLEX UD-320-1000 (available from King Industries in Norwalk, Conn.) is a polyurethane polyol.

MaAcAc (available from Aldrich Chemical Company in Milwaukee, Wis.) is 2-(methacryloyloxy)ethyl acetoacetate.

Music wire (0.005″ and 0.010″ in diameter) (available from Small Parts Inc. in Miramar, Fla.).

PARALOID EXL 2600 (available from Rohm and Haas Company in Philadelphia, Pa., USA) is a methacrylate/butadiene/styrene polymer with a core/shell architecture (core cross-linked rubber comprising of a polybutadiene-co-polystyrene-copolymer; shell: polymethacrylate) with a particle size of ca. 250 nm.

PARALOID EXL 2691 (available from Rohm and Haas Company in Philadelphia, Pa.) is a methacrylate/butadiene/styrene polymer with a core/shell architecture (core crosslinked rubber comprising of a polybutadiene-co-polystyrene-copolymer; shell: polymethacrylate) with a particle size of ca. 250 nm.

PEG₁₀₀₀DGE (available from Polysciences, Inc. in Warrington, Pa.) is a poly(ethylene glycol) (n) diglycidyl ether (CAS No. 26403-72-5), with the molecular weight of the poly(ethylene glycol) unit, n, equal to 1000 and having an approximate epoxy equivalent weight of 600.

SHIELDEX AC5 (available from W.R. Grace in Columbia, Md., USA) is a calcium-treated fumed silica corrosion inhibitor.

SILANE Z-6040 (available from Dow Corning, Midland, Mich.) is (3-Glycidyloxypropyl)trimethoxysilane, an adhesion promoter/coupling agent.

SR602 (available from Sartomer Company, Inc. in Exton, Pa.) is an ethoxylated (10) bisphenol A diacrylate.

T-butyl acetoacetate (available from Aldrich Chemical Company in Milwaukee, Wis.).

VAZO-52 (available from DuPont Chemicals in Wilmington, Del.) is an azo free-radical initiator.

VAZO-67 or AIBN (available from DuPont Chemicals in Wilmington, Del.) is azoisobutyronitrile.

Zeller-Gmelin KTL N16 (available from Zeller+Gmelin GmbH & Co. KG in Eislingen, Germany) is a deep-draw oil.

### Preparation of Test Specimens

Preparation of test specimens was based upon ASTM Specification D 6386-99 and Society for Protective Coatings Surface Preparation Specifications and Practices Surface Preparation Specification No. 1.

Clean Steel Panels. Iron phosphated steel panels (Type “RS” Steel, 4″×1″×0.063″, Square Corners, Iron Phosphated (B-1000) available from Q-Lab Corporation in Cleveland, Ohio) or cold-rolled steel panels (Type “S” Steel, 12″×1″×0.032″, Square Corners, 1010 CRS available from Q-Lab Corporation in Cleveland, Ohio) were wiped with a 50:50 mixture by volume of heptane to acetone. The panels were then dipped for 60 seconds in an alkaline cleaner bath (45 g/L of sodium triphosphate and 45 g/L of Alconox cleaner) maintained at 80° C. The panels were subsequently rinsed in distilled deionized water and dried in an oven at 80° C. The ground side of the panel was used for all testing.

Oiled Steel Panels. Oiled steel panels were prepared by applying a specified volume of oil to cleaned steel to achieve a coating of 3 g/m² for the area to be coated, using density data obtained from the appropriate oil MSDS. A clean fingertip of a nitrile glove was used to carefully spread the oil uniformly over the surface. The surface was then covered and the steel panel was stored at room temperature for 24 hours prior to use.

Etched Aluminum Panels. Aluminum panels (4″×7″×0.063″ or 3″×8″×0.025″ 2024-T3 bare aluminum) were etched using the Optimized Forest Products Laboratory (FLP) process. The aluminum panels were immersed for 10 minutes in an alkaline degreaser (15,308.74 grams ISOPREP 44 to 63 gallons of water) maintained at 88° C. The aluminum panels were removed from the degreaser and rinsed with tap water. The panels were then immersed for 10 minutes in an FPL etch bath (10,697 grams sodium dichromate, 72,219 grams 96% sulfuric acid, 358 grams 2024T3 bare aluminum, and 63.1 gallons water) maintained at 55-60° C. After removal from the etch bath, the panels were rinsed with tap water, air dried for 10 minutes, and then force dried for an additional 10 minutes at 55-60° C.

### Example 1

### Adhesive Compositions

Six adhesive compositions were prepared as summarized in Table 1 and described in further detail below.

TABLE 1

| | C1(g) | K1(g) | C2(g) | K2(g) | C3(g) | K3(g) |
|---|---|---|---|---|---|---|
| EPON 828 | 100 | 100 | 85 | 85 | 90 | 90 |
| EPONEX 1510 | 0 | 0 | 15 | 15 | 0 | 0 |
| PEG₁₀₀₀DGE | 0 | 0 | 0 | 0 | 10 | 10 |
| PARALOID EXL | 15 | 15 | 15 | 15 | 15 | 15 |
| 2691 | | | | | | |
| K-FLEX XMB- | 0 | 13.1 | 0 | 13.1 | 0 | 13.1 |
| 301 | | | | | | |
| ANCAMINE 2441 | 20 | 22.6 | 19.7 | 22.3 | 18.8 | 21.4 |
| AEROSIL VP- | 2 | 2 | 2 | 2 | 2 | 2 |
| R-2935 | | | | | | |

Preparation of Epoxy Adhesive C1. 100 grams of EPON 828 were added to a one pint metal can. 15 grams of PARALOID EXL 2691 were slowly added and mixed into the EPON 828 over the course of 15 minutes. This mixture was subsequently heated to 80° C. and maintained at that temperature for 90 minutes. The EPON 828 mixture was removed from the heat and allowed to cool to room temperature. Once at room temperature, 20 grams of ANCAMINE 2441 were added to the mixture and mixed until homogeneous. Then, 2 grams of AEROSIL VP-R-2935 were added to the mixture and mixed until homogeneous. In all stages of the process, the solution was continuously stirred. After all ingredients were added, the resultant adhesive was degassed and stored in a closed container at 4° C. until use.

Prior to use, the adhesive was warmed to room temperature, and 1% by weight of glass beads (212-300 μm in diameter) were thoroughly mixed into the adhesive.

Preparation of Epoxy Adhesive K1. 100 grams of EPON 828 were added to a one pint metal can. 15 grams of PARALOID EXL 2691 were slowly added and mixed into the EPON 828 over the course of 15 minutes. This mixture was subsequently heated to 80° C. and maintained at that temperature for 90 minutes. The

EPON 828 mixture was removed from the heat and allowed to cool to room temperature. Once at room temperature, 13.1 grams of K-FLEX XMB-301 were added to the mixture and mixed until homogeneous. Next, 22.6 grams of ANCAMINE 2441 were added to the mixture and mixed until homogeneous. Then, 2 grams of AEROSIL VP-R-2935 were added to the mixture and mixed until homogeneous. In all stages of the process, the solution was continuously stirred. After all ingredients were added, the resultant adhesive was degassed and stored in a closed container at 4° C. until use. Prior to use, the adhesive was warmed to room temperature, and 1% by weight of glass beads (212-300 μm in diameter) were thoroughly mixed into the adhesive.

Preparation of Epoxy Adhesive C2. 85 grams of EPON 828 and 15 grams of EPONEX 1510 were added to a one pint metal can and mixed until homogenized. 15 grams of PARALOID EXL 2691 were slowly added and mixed into the EPON 828 mixture over the course of 15 minutes. This mixture was subsequently heated to 80° C. and maintained at that temperature for 90 minutes. The EPON 828 mixture was removed from the heat and allowed to cool to room temperature. Once at room temperature, 19.7 grams of ANCAMINE 2441 were added to the mixture and mixed until homogeneous. Then, 2 grams of AEROSIL VP-R-2935 were added to the mixture and mixed until homogeneous. In all stages of the process, the solution was continuously stirred. After all ingredients were added, the resultant adhesive was degassed and stored in a closed container at 4° C. until use. Prior to use, the adhesive was warmed to room temperature, and 1% by weight of glass beads (212-300 μm in diameter) were thoroughly mixed into the adhesive.

Preparation of Epoxy Adhesive K2. 85 grams of EPON 828 and 15 grams of EPONEX 1510 were added to a one pint metal can and mixed until homogenized. 15 grams of PARALOID EXL 2691 were slowly added and mixed into the EPON 828 mixture over the course of 15 minutes. This mixture was subsequently heated to 80° C. and maintained at that temperature for 90 minutes. The EPON 828 mixture was removed from the heat and allowed to cool to room temperature. Once at room temperature, 13.1 grams of K-FLEX XMB-301 were added to the mixture and mixed until homogeneous. Next, 22.3 grams of ANCAMINE 2441 were added to the mixture and mixed until homogeneous. Then, 2 grams of AEROSIL VP-R-2935 were added to the mixture and mixed until homogeneous. In all stages of the process, the solution was continuously stirred. After all ingredients were added, the resultant adhesive was degassed and stored in a closed container at 4° C. until use. Prior to use, the adhesive was warmed to room temperature, and 1% by weight of glass beads (212-300 μm in diameter) were thoroughly mixed into the adhesive.

Preparation of Epoxy Adhesive C3. 90 grams of EPON 828 and 10 grams of PEG₁₀₀₀DGE were added to a one pint metal can and mixed until homogenized. 15 grams of PARALOID EXL 2691 were slowly added and mixed into the EPON 828 mixture over the course of 15 minutes. This mixture was subsequently heated to 80° C. and maintained at that temperature for 90 minutes. The EPON 828 mixture was removed from the heat and allowed to cool to room temperature. Once at room temperature, 18.8 grams of ANCAMINE 2441 were added to the mixture and mixed until homogeneous. Then, 2 grams of AEROSIL VP-R-2935 were added to the mixture and mixed until homogeneous. In all stages of the process, the solution was continuously stirred. After all ingredients were added, the resultant adhesive mixture was degassed and stored in a closed container at 4° C. until use. Prior to use, the adhesive was warmed to room temperature, and 1% by weight of glass beads (212-300 μm in diameter) were thoroughly mixed into the adhesive.

Preparation of Epoxy Adhesive K3. 90 grams of EPON 828 and 10 grams of PEG₁₀₀₀DGE were added to a one pint metal can and mixed until homogenized. 15 grams of PARALOID EXL 2691 were slowly added and mixed into the EPON 828 mixture over the course of 15 minutes. This mixture was subsequently heated to 80° C. and maintained at that temperature for 90 minutes. The EPON 828 mixture was removed from the heat and allowed to cool to room temperature. Once at room temperature, 13.1 grams of K-FLEX XMB-301 were added to the mixture and mixed until homogeneous. Next, 21.4 grams of ANCAMINE 2441 were added to the mixture and mixed until homogeneous. Then, 2 grams of AEROSIL VP-R-2935 were added to the mixture and mixed until homogeneous. In all stages of the process, the solution was continuously stirred. After all ingredients were added, the resultant adhesive mixture was degassed and stored in a closed container at 4° C. until use. Prior to use, the adhesive was warmed to room temperature, and 1% by weight of glass beads (212-300 μm in diameter) were thoroughly mixed into the adhesive.

In general, the adhesives containing K-FLEX XMB-301 (that is, K1, K2 and K3) exhibit increased performance over those adhesives that did not contain K-FLEX XMB-301 (that is, C1, C2 and C3), as demonstrated by the lap shear strength and T-peel strength measurements summarized below in Examples 2-5.

### Example 2

### Lap Shear Strength and T-Peel Strength of Adhesives in Example 1 Cured on Clean Steel at 110° C. for 30 Minutes

Lap Shear Strength of Adhesives Lap shear specimens were made using prepared iron phosphated steel panels measuring 4×″1″×0.063″ that were cleaned as described above. Each specimen was generated as described in ASTM Specification D 1002-05. A strip of approximately ½″ wide and 0.010″ thick of adhesive was applied to one edge of each of two adherends using a scraper. Glass beads (212-300 μm in diameter) within the adhesive served as spacers. One adherend was taped in place on a foil-covered cardboard sheet. The second adherend was aligned to overlap the ½″ adhesive bondline between the two adherends, and the bond was closed. The second adherend was carefully taped in place, taking care not to disturb the bondline. This was done for each bond for each testing condition, with a minimum of five bonds for each. Two 14# steel plates preheated to 110° C. were carefully placed on top of the specimens and inserted into a preheated heat press, with enough pressure added to ensure contact of the plates. The specimens were cured at 110° C. for 30 minutes. After the adhesive had been allowed to cure, the bonds were tested to failure at room temperature on a Sintech Tensile Testing machine using a crosshead displacement rate of 0.1″/min. The failure load was recorded. The lap width was measured with a vernier caliper. The quoted lap shear strengths were calculated as failure load/(measured width of bond×measured length of bond). The average and standard deviation were calculated from the results of at least five tests unless otherwise noted.

T-Peel Strength of Adhesives T-peel specimens were made using the prepared cold rolled steel test specimens measuring 12×1×0.032″ that were cleaned as described above. The specimen was generated as described in ASTM D-1876. Two sets of specimens were placed side-by-side, and a strip of approximately 1″×9″×10 mil of adhesive was applied to each adherend. Glass beads (212-300 μm in diameter) within the adhesive served as spacers. The bond was closed and adhesive tape was applied to hold the adherends together during the cure. The adhesive bonds were placed between sheets of aluminum foil and also between pieces of cardboard. Two 14# steel plates preheated to 110° C. were carefully placed on top of the specimens and inserted into a preheated heat press, with enough pressure added to ensure contact of the plates. The specimens were cured at 110° C. for 30 minutes. After the adhesive had been allowed to cure, the bonds were tested to failure at room temperature on a Sintech Tensile Testing machine using a crosshead displacement rate of 12″/min. The initial part of the loading data was ignored. The average load was measured after about 1″ was peeled. The quoted T-peel strength was the average of two peel measurements.

The results of the lap shear strength test and T-peel strength test for each adhesive applied to clean steel and cured at 110° C. for 30 minutes is summarized in Table 2.

TABLE 2

| Adhesive | Lap Shear Strength (psi) | T-Peel Strength (lb_{f}/in-width) |
|---|---|---|
| C1 | 3203 ± 74 | 0.95 ± 0.09 |
| K1 | 4052 ± 266 | 5.36 ± 0.52 |
| C2 | 2747 ± 453 | 1.04 ± 0.06 |
| K2 | 3552 ± 447 | 7.08 ± 1.05 |
| C3 | 2854 ± 114 | 1.51 ± 0.14 |
| K3 | 3282 ± 205 | 11.80 ± 0.98 |

All adhesive compositions exhibited cohesive failure during lap shear testing. However, adhesive compositions C1, C2 and C3 exhibited adhesive failure during T-peel testing, whereas adhesive compositions K1, K2, and K3 exhibited cohesive failure.

### Example 3

### Lap Shear Strength and T-Peel Strength of Adhesives in Example 1 Cured on Clean Steel at 125° C. for 30 Minutes

Lap shear and T-peel measurements as described in Example 2 were repeated except that the adhesive bonds were cured at 125° C. The results are summarized in Table 3.

TABLE 3

| Adhesive | Lap Shear Strength (psi) | T-Peel Strength (lb_{f}/in-width) |
|---|---|---|
| C1 | 3593 ± 261 | 6.00 ± 1.41 |
| K1 | 4856 ± 392 | 20.09 ± 3.33 |
| C2* | 2438 ± 241 | 4.01 ± 0.29 |
| K2 | 3895 ± 347 | 31.76 ± 9.25 |
| C3 | 3855 ± 266 | 6.26 ± 2.05 |
| K3 | 4543 ± 250 | 45.41 ± 4.72 |

*Denotes only four lap shear samples tested

All adhesive compositions exhibited cohesive failure during lap shear testing. Adhesive compositions C1 and C2 exhibited adhesive failure during T-peel testing, whereas adhesive compositions C3, K1, K2, and K3 exhibited cohesive failure.

### Example 4

### Lap Shear Strength and T-Peel Strength of Adhesives in Example 1 Cured on Oiled Steel at 110° C. for 30 Minutes

Lap shear and T-peel specimens were generated as described in Example 2 on steel test specimens oiled with 3 g/m² Zeller-Gmelin KTL N16 oil. The adhesive bonds were cured at 110° C. for 30 minutes. The results are summarized in Table 4.

TABLE 4

| Adhesive | Lap Shear Strength (psi) | T-Peel Strength (lb_{f}/in-width) |
|---|---|---|
| C1 | 2767 ± 356 | 5.05 ± 1.03 |
| K1* | 3639 ± 239 | 3.93 ± 1.07 |
| C2 | 2145 ± 415 | 3.15 ± 0.87 |
| K2 | 3135 ± 376 | 13.42 ± 1.98 |
| C3 | 2798 ± 304 | 2.70 ± 0.49 |
| K3 | 2921 ± 309 | 15.85 ± 3.62 |

*Denotes only four lap shear samples tested.

All adhesive compositions exhibited cohesive failure during lap shear testing. Adhesive composition C3 exhibited adhesive failure during T-peel testing, whereas adhesive compositions C1, C2, K1, K2, and K3 exhibited apparent mixed mode failure.

### Example 5

### Lap Shear Strength and T-Peel Strength of Adhesives in Example 1 Cured on Oiled Steel at 125° C. for 30 Minutes

Lap shear and T-peel measurements as described in Example 4 were repeated except that the adhesive bonds were cured at 125° C. The results are summarized in Table 5.

TABLE 5

| Adhesive | Lap Shear Strength (psi) | T-Peel Strength (lb_{f}/in-width) |
|---|---|---|
| C1 | 3728 ± 168 | 5.06 ± 0.59 |
| K1 | 4151 ± 444 | 21.87 ± 3.56 |
| C2 | 2384 ± 404 | 5.41 ± 0.25 |
| K2 | 3737 ± 230 | 33.68 ± 2.07 |
| C3 | 2810 ± 193 | 8.66 ± 0.51 |
| K3 | 3735 ± 197 | 42.66 ± 3.27 |

All adhesive compositions exhibited cohesive failure during lap shear testing. All adhesive compositions exhibited apparent mixed mode failure during T-peel testing.

### Example 6

### Adhesive Composition

An adhesive composition was prepared as summarized in Table 6 and described in further detail below.

TABLE 6

| | K4 (g) |
|---|---|
| EPON 828 | 75 |
| EPONEX 1510 | 15 |
| EPON 872 | 10 |
| PARALOID EXL 2691 | 15 |
| K-FLEX XMB-301 | 13.1 |
| ANCAMINE 2441 | 26.24 |
| AEROSIL VP-R-2935 | 2 |

Preparation of Epoxy Adhesive K4. 75 grams of EPON 828, 15 grams of

EPONEX 1510 and 10 grams of EPON 872 were added to a one pint metal can and mixed until homogenized. 15 grams of PARALOID EXL 2691 were slowly added and mixed into the EPON 828 mixture over the course of 15 minutes. This mixture was subsequently heated to 80° C. and maintained at that temperature for 90 minutes. The EPON 828 mixture was removed from the heat and allowed to cool to room temperature. Once at room temperature, 13.1 grams of K-FLEX XMB-301 were added to the mixture and mixed until homogeneous. Next, 26.24 grams of ANCAMINE 2441 were added to the mixture and mixed until homogeneous. Then, 2 grams of AEROSIL VP-R-2935 were added to the mixture and mixed until homogeneous. In all stages of the process, the mixture was continuously stirred. After all ingredients were added, the resultant adhesive was degassed and stored in a closed container at room temperature until use.

### Example 7

### Lap Shear Strength and T-Peel Strength of Adhesive in Example 6 Cured on Clean Steel at 177° C. for 20 Minutes

Lap Shear Strength of Adhesives Lap shear specimens were made using the prepared galvanized steel test specimens measuring 4″×1×″0.063″ that were cleaned as described above. The specimen was generated as described in ASTM Specification D 1002-05. A strip of approximately ½″ wide and 0.010″ thick of adhesive was applied to one edge of each of the two adherends using a scraper. Two 0.005″ music wires were placed on each edge of the bond (parallel to the direction of shear) to serve as spacers. The bond was closed and clamped using a 1″ binder clip to apply pressure to provide for adhesive spreading. At least five bonds were made for each testing condition. The adhesive was then cured for 20 minutes at 177° C. in a forced air oven. After curing, the bonds were tested to failure at room temperature on a Sintech Tensile Testing machine using a crosshead displacement rate of 0.1″/min. The failure load was recorded. The lap width was measured with a vernier caliper. The quoted lap shear strengths were calculated as failure load/(measured width of the bond×measured length of the bond). The average and standard deviation were calculated from the results of at least five tests unless otherwise noted.

T-Peel Strength of Adhesives T-peel specimens were made using the prepared cold rolled steel test specimens measuring 12″×1″×0.032″ that were cleaned as described above. The specimen was generated as described in ASTM D-1876. Two sets of specimens were placed side-by-side, and a strip of approximately 1″×9″×10 mil of adhesive was applied to each adherend. Three 0.010″ music wires were placed perpendicular to the direction of peel in the bond, one at the start of the bond, one approximately in the middle of the bond, and one at the end of the bond to serve as spacers. The bond was closed and adhesive tape was applied to hold the adherends together during the cure. The adhesive bonds were placed between sheets of aluminum foil and also between pieces of cardboard. Two 14# steel plates were applied to promote adhesive spreading. The adhesive was then cured for 20 minutes at 177° C. in a forced air oven. After the adhesive had been allowed to cure, the bonds were tested to failure at room temperature on a Sintech Tensile Testing machine using a crosshead displacement rate of 12″/min. The initial part of the loading data was ignored. The average load was measured after about 1″ was peeled. The quoted T-peel strength is the average of two peel measurements.

The results of the lap shear strength and T-peel strength test for the adhesive applied to clean steel and cured at 177° C. for 20 minutes is summarized in Table 7.

TABLE 7

| Adhesive | Lap Shear Strength (psi) | T-Peel Strength (lb_{f}/in-width) |
|---|---|---|
| K4 | 5240 ± 761 | 64.5 ± 5.6 |

The K4 adhesive composition exhibited cohesive failure during both lap shear testing and T-peel testing.

### Example 8

### Lap Shear Strength and T-Peel Strength of Adhesive in Example 6 Cured on Oiled Steel at 177° C. for 20 Minutes

Example 7 was repeated on steel test specimens oiled with 3 g/m² Zeller-Gmelin KTL N16 oil. The adhesive bonds were cured at 177° C. for 20 minutes. The results are summarized in Table 8.

TABLE 8

| Adhesive | Lap Shear Strength (psi) | T-Peel Strength (lb_{f}/in-width) |
|---|---|---|
| K4 | 4684 ± 197 | 53.1 ± 3.8 |

The K4 adhesive composition exhibited cohesive failure during both lap shear testing and T-peel testing.

### Example 9

### Adhesive Compositions Comprising Mineral Fiber

Two adhesive compositions were prepared as summarized in Table 9 and described in further detail below.

TABLE 9

| | C5 (g) | K5 (g) |
|---|---|---|
| EPON 828 | 85 | 85 |
| EPONEX 1510 | 15 | 15 |
| PARALOID EXL 2691 | 15 | 15 |
| K-FLEX XMB-301 | 0 | 13.1 |
| ANCAMINE 2441 | 19.7 | 22.3 |
| COATFORCE ® CF50 | 8 | 8 |

Preparation of Epoxy Adhesive C5. 85 grams of EPON 828 were mixed with 15 grams of EPONEX 1510 in a one pint metal can. 15 grams of PARALOID EXL 2691 were slowly added and mixed into the EPON 828 mixture over the course of 15 minutes. This mixture was subsequently heated to 80° C. and maintained at that temperature for 90 minutes. The EPON 828 mixture was removed from the heat and allowed to cool to room temperature. Once at room temperature, 19.7 grams of ANCAMINE 2441 were added to the mixture and mixed until homogeneous. 8 grams of Lapinus CoatForce CF50 fibers were added to the EPON 828 mixture, and the mixture was stirred at 800 RPM until the fibers were well dispersed in the mixture (approximately five minutes). In all stages of the process, the mixture was continuously stirred. After all ingredients were added, the resultant adhesive was degassed and stored in a closed container at room temperature until use.

Preparation of Epoxy Adhesive K5. 85 grams of EPON 828 were mixed with 15 grams of EPONEX 1510 in a one pint metal can. 15 grams of PARALOID EXL 2691 were slowly added and mixed into the EPON 828 over the course of 15 minutes. This mixture was subsequently heated to 80° C. and maintained at that temperature for 90 minutes. The EPON 828 mixture was removed from the heat and allowed to cool to room temperature. Once at room temperature, 13.1 grams of K-FLEX XMB-301 were added to the mixture and mixed until homogeneous. Next, 22.3 grams of ANCAMINE 2441 were added to the mixture and mixed until homogeneous. 8 grams of Lapinus CoatForce CF50 fibers were added to the EPON 828 mixture, and the mixture was stirred at 800 RPM until the fibers were well dispersed in the mixture (approximately five minutes). In all stages of the process, the mixture was continuously stirred. After all ingredients were added, the resultant adhesive was degassed and stored in a closed container at room temperature until use.

### Example 10

### Lap Shear Strength and T-Peel Strength of Adhesives in Example 9 Cured on Oiled Steel at 177° C. for 20 Minutes

The lap shear strength test and T-peel strength test were performed according to the procedure in Example 8 for each adhesive applied to oiled steel panels. The adhesive bonds were cured at 177° C. for 20 minutes. The results are summarized in Table 10.

TABLE 10

| Adhesive | Lap Shear Strength (psi) | T-Peel Strength (lb_{f}/in-width) |
|---|---|---|
| C5 | 4472 ± 218 | 17.7 ± 2.6 |
| K5 | 4863 ± 366 | 28.1 ± 1.2 |

The adhesive compositions C5 and K5 exhibited cohesive failure for both lap shear and T-peel testing.

### Example 11

### Adhesive Composition

An adhesive composition was prepared as summarized in Table 11 and described in further detail below.

TABLE 11

| | K6 (g) |
|---|---|
| EPON 828 | 60 |
| EPONEX 1510 | 10 |
| EPON 1001F | 20 |
| DER 732 | 10 |
| PARALOID EXL 2600 | 25 |
| MaAcAc 2000 MW | 13.1 |
| Oligomer* | |
| SILANE Z-6040 | 3.8 |
| APYRAL 24 ES2 | 8 |
| SHIELDEX AC5 | 8 |
| CAB-O-SIL TS720 | 8 |
| ANCAMINE 2441 | 18.67 |

*Synthesis provided in Example 13.

Preparation of Epoxy Adhesive K6. 60 grams of EPON 828, 10 grams of EPONEX 1510, 20 grams of EPON 1001F and 10 grams of DER 732 were added to a one pint metal can and mixed until homogenized. 25 grams of PARALOID EXL 2600 were slowly added and mixed into the EPON 828 mixture over the course of 15 minutes. This mixture was subsequently heated to 80° C. and maintained at that temperature for 90 minutes. The EPON 828 mixture was removed from the heat and allowed to cool to room temperature. Once at room temperature, 13.1 grams of MaAcAc 2000 MW Oligomer (prepared as described in Example 13) were added to the mixture and mixed until homogeneous. Then 3.8 grams of SILANE Z-6040 were added to the mixture and mixed until homogeneous. 8 grams of APYRAL 24 ES2 and 8 grams of SHIELDEX AC5 were added to the mixture and mixed for 60 seconds at 3000 RPM. Then 8 grams of CAB-O-SIL TS720 were added to the mixture and mixed for 60 seconds at 3000 RPM. The mixture was allowed to return to room temperature. Next, 18.67 grams of ANCAMINE 2441 were added to the mixture and mixed until homogeneous. In all stages of the process, the mixture was continuously stirred. After all ingredients were added, the resultant adhesive was degassed and stored in a closed container at room temperature until use.

### Example 12

### Lap Shear Strength and T-Peel Strength of Adhesive in Example 11 Cured on Clean Steel and Aluminum at 177° C. for 20 Minutes

Lap Shear Strength of Adhesive. Lap shear specimens were made using either prepared galvanized steel test specimens measuring 4″×1″×0.063″ that were cleaned as described above or 4″×7×″0.063″ 2024-T3 bare aluminum that had been etched using the FPL process described above.

Each specimen was generated as described in ASTM Specification D 1002-05. A strip of approximately ½″ wide and 0.010″ thick of adhesive was applied to one edge of each of two adherends using a scraper. Glass beads (212-300 μm in diameter) within the adhesive served as spacers. One adherend was taped in place on a foil-covered cardboard sheet. The second adherend was aligned to overlap the ½″ adhesive bondline between the two adherends, and the bond was closed. The second adherend was carefully taped in place, taking care not to disturb the bondline. This was done for each bond for each testing condition, with a minimum of five bonds for each. Two 14# steel plates preheated to 177° C. were carefully placed on top of the specimens and inserted into a preheated heat press, with enough pressure added to ensure contact of the plates. The specimens were cured at 177° C. for 20 minutes. After the adhesive had been allowed to cure, the bonds were tested to failure at room temperature on a Sintech Tensile Testing machine using a crosshead displacement rate of 0.1″/min. The failure load was recorded. The lap width was measured with a vernier caliper. The quoted lap shear strengths were calculated as failure load/(measured width of bond×measured length of bond). The average and standard deviation were calculated from the results of at least five tests unless otherwise noted.

T-Peel Strength of Adhesive. T-peel specimens were made using either prepared cold rolled steel test specimens measuring 12″×1″×0.032″ that were cleaned as described above or 3″×8″×0.025″ 2024-T3 bare aluminum that had been etched using the FPL process described above.

Each specimen was generated as described in ASTM D-1876. For the cold rolled steel specimens, two sets of specimens were placed side-by-side, and a strip of approximately 1×″9″×10 mil of adhesive was applied to each adherend. Glass beads (212-300 μm in diameter) within the adhesive served as spacers. For the etched aluminum specimens, a strip of approximately 2″×5″×10 mil of adhesive was applied to both of the two adherends. 10 mil thick spacers made from brass shims were applied to the edges of the bonded area for bondline thickness control. The bond was closed and adhesive tape was applied to hold the adherends together during the cure. The adhesive bonds were placed between sheets of aluminum foil and also between pieces of cardboard. Two 14# steel plates preheated to 177° C. were carefully placed on top of the specimens and inserted into a preheated heat press, with enough pressure added to ensure contact of the plates. The specimens were cured at 177° C. for 20 minutes. After the adhesive had been allowed to cure, the larger specimen was cut into 1″ wide samples, yielding two 1″ wide specimens. The bonds were tested to failure at room temperature on a Sintech Tensile Testing machine using a crosshead displacement rate of 12″/min. The initial part of the loading data was ignored. The average load was measured after about 1″ was peeled. The quoted T-peel strength is the average of two peel measurements.

The results of the lap shear strength test and T-peel strength test for the adhesive cured at 177° C. for 20 minutes on both clean steel and aluminum is summarized in Table 12.

TABLE 12

| | | T-Peel Strength |
|---|---|---|
| Adhesive | Lap Shear Strength (psi) | (lb_{f}/in-width) |
| K6 (clean steel) | 2671 ± 413 | 63.5 ± 1.7 |
| K6 (clean aluminum) | 2615 ± 249 | 23.9 ± 6.0 |

The adhesive composition on both clean steel and aluminum exhibited cohesive failure during both lap shear testing and T-peel testing.

### Example 13

### Synthesis of Various Reactive Liquid Modifiers

Oxamido Ester Terminated Polypropylene Oxide. The oxamido ester-terminated polypropylene oxide was prepared according to the below reaction scheme:

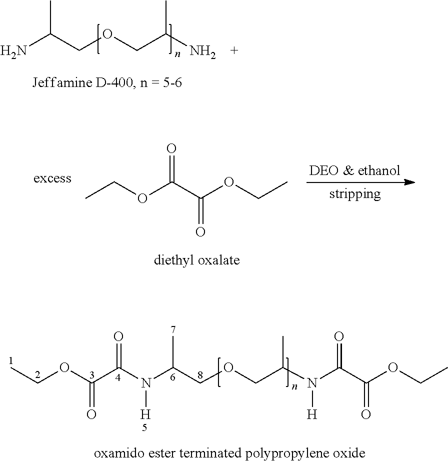

To a 2 L flask was added 730.70 grams sieve dried diethyloxalate and sufficient argon to purge the headspace. Using an addition funnel, 200.00 grams JEFFAMINE® D-400 were added to the flask over the course of 90 minutes with vigorous stirring. Using a set up for distillation-argon sparge (sub-surface), the temperature of the contents in the flask was slowly increased to 150° C. in order to distill out excess diethyloxalate and ethanol. The resultant product was a wisky brown, clear liquid weighing 273.2 grams and having a viscosity of 3,400 cP.

MaAcAc 1000 MW Oligomer. 20 grams MaAcAc, 4.75 grams IOTGA, 0.051 grams VAZO 67 and 30 grams ethyl acetate were charged to a 4 oz. glass polymerization bottle. The bottle was purged with nitrogen for five minutes, sealed, and placed in a water bath maintained at 60° C. for 24 hours. The reaction mixture was then removed from the bath, and the solvent was stripped under vacuum. Peak ratio of the tail fragment protons to the backbone protons in ¹H NMR (in CDCl₃) indicated approximately 4.65 repeat units per molecule, or an epoxide equivalent weight (EEW) of 270.

MaAcAc 2000 MW Oligomer. 20 grams of MaAcAc, 2.32 grams IOTGA, 0.051 grams VAZO 67 and 30 grams ethyl acetate were charged to a 4 oz. glass polymerization bottle. The bottle was purged with nitrogen for five minutes, sealed, and placed in a water bath maintained at 60° C. for 24 hours. The reaction mixture was then removed from the bath, and the solvent was stripped under vacuum. Peak ratio of the tail fragment protons to the backbone protons in ¹H NMR (in CDCl₃) indicated an EEW of 243.

Urethane diAcAc #1. 35 grams t-butyl acetoacetate were added to 20 grams K-FLEX UD-320-100. The resultant mixture was heated to 120° C. and refluxed overnight using a vigoreaux condenser. The reaction product was then distilled under vacuum to remove the excess t-butyl acetoacetate. ¹H NMR (in CDCl₃) confirms essentially pure Urethane diAcAc #1.

Urethane diAcAc #2. 50 grams t-butyl acetoacetate were added to 20 grams K-FLEX XM-311. The resultant mixture was heated to 120° C. and refluxed overnight using a vigoreaux condenser. The reaction product was then distilled under vacuum to remove the excess t-butyl acetoacetate. ¹H NMR (in CDCl₃) confirms essentially pure Urethane diAcAc #2.

The embodiments described above are presented by way of example only and are not intended as a limitation upon the concepts and principles of the present invention. As such, it will be appreciated by one having ordinary skill in the art that various changes in the elements and their configuration and arrangement are possible without departing from the spirit and scope of the present invention.

Thus, the invention provides, among other things, a one-part epoxy-based structural adhesive and method for bonding parts using the structural adhesive. Various features and advantages of the invention are set forth in the following claims.

1. An adhesive comprising:
an epoxy resin;
a toughening agent;
a reactive liquid modifier present in an amount ranging from about 5% to about 15% by weight adhesive, the reactive liquid modifier selected from the group consisting of acetoacetoxy-functionalized compounds, oxamide-based modifiers, and combinations thereof; and
a latent amine curing agent.

2. The adhesive of claim 1, wherein the amount of reactive liquid modifier is present in an amount ranging from about 7% to about 12% by weight adhesive.

3. The adhesive of claim 1, wherein the reactive liquid modifier is an acetoacetoxy-functionalized compound.

4. The adhesive of claim 3, wherein the reactive liquid modifier is a compound having the general formula 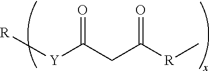
wherein
X is an integer from 1 to 10;
Y is O, S or NH;
R is a residue selected from the group of residues consisting of polyhydroxy alkyl, polyhydroxy aryl or a polyhydroxy alkylaryl; polyoxy alkyl, polyoxy aryl and polyoxy alkylaryl; polyoxy polyhydroxy alkyl, -aryl, -alkylaryl; polyether polyhydroxy alkyl, -aryl or -alkylaryl; or polyester polyhydroxy alkyl, -aryl or -alkylaryl, wherein R is linked to Y via a carbon atom; and
R′ is a C₁-C₁₂ linear or branched or cyclic alkyl.

5. The adhesive of claim 1, further comprising an inorganic mineral fiber.

6. The adhesive of claim 1, wherein the adhesive has a lap shear strength of at least 2500 psi when cured at 110° C. for 30 minutes.

7. The adhesive of claim 1, wherein the adhesive has a T-peel strength of at least 3.0 lb_{f}/in-width when cured at 110° C. for 30 minutes.

8. The adhesive of claim 1 comprising about 20% to about 90% by weight of the epoxy resin, about 5% to about 55% by weight of the toughening agent, and about 5% to about 25% by weight of the latent amine curing agent.

9. The adhesive of claim 1, wherein the epoxy resin comprises a fatty-acid modified diglycidyl ether of bis-phenol A.

10. The adhesive of claim 5, wherein the inorganic mineral fiber comprises from about 37% to about 42% by weight SiO₂, from about 18% to about 23% by weight Al₂O₃, from about 34% to about 39% by weight CaO+MgO, from 0% to about 1% by weight FeO, and about 3% by weight K₂O+Na₂O.

11. A method of forming a bonded joint between two substrates comprising:
providing an adhesive comprising an epoxy resin, a toughening agent, a reactive liquid modifier present in an amount ranging from about 5% to about 15% by weight adhesive, and a latent amine curing agent;
applying the adhesive to at least one of two substrates;
joining the substrates so that the adhesive is sandwiched between the two substrates; and
curing the adhesive to form a bonded joint.

12. The method of claim 11, wherein the reactive liquid modifier is an acetoacetoxy-functionalized compound.

13. The method of claim 12, wherein the reactive liquid modifier is an acetoacetoxy-functionalized compound having the general formula 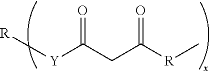
wherein
X is an integer from 1 to 10;
Y is O, S or NH;
R is a residue selected from the group of residues consisting of polyhydroxy alkyl, polyhydroxy aryl or a polyhydroxy alkylaryl; polyoxy alkyl, polyoxy aryl and polyoxy alkylaryl; polyoxy polyhydroxy alkyl, -aryl, -alkylaryl; polyether polyhydroxy alkyl, -aryl or -alkylaryl; or polyester polyhydroxy alkyl, -aryl or -alkylaryl, wherein R is linked to Y via a carbon atom; and
R′ is a C₁-C₁₂ linear or branched or cyclic alkyl.

14. The method of claim 11, further comprising an inorganic mineral fiber.

15. The method of claim 11, wherein the adhesive has a lap shear strength of at least 2500 psi when cured at 110° C. for 30 minutes.

16. The method of claim 11, wherein the adhesive has a T-peel strength of at least 3.0 lb_{f}/in-width when cured at 110° C. for 30 minutes.

17. The method of claim 11 wherein the adhesive comprises about 20% to about 90% by weight of the epoxy resin, about 5% to about 55% by weight of the toughening agent, and about 5% to about 25% by weight of the latent amine curing agent.

18. The method of claim 11, wherein at least one substrate is contaminated with hydrocarbon-containing material.

19. The method of claim 11, wherein at least one substrate is a metal.

20. The method of claim 14, wherein the inorganic mineral fiber comprises from about 37% to about 42% by weight SiO₂, from about 18% to about 23% by weight Al₂O₃, from about 34% to about 39% by weight CaO+MgO, from 0% to about 1% by weight FeO, and about 3% by weight K₂O+Na₂O.

21. The method of claim 20, wherein at least one substrate is contaminated with hydrocarbon-containing material.

22. The method of claim 20, wherein at least one substrate is a metal.
